(19) United States
(12) Patent Application Publication
(10) Pub. No.: US 2025/0067277 A1
(43) Pub. Date: Feb. 27, 2025

(54) INDUSTRIAL AXIAL FAN BLADE

(71) Applicant: COFIMCO S.R.L, POMBIA (IT)

(72) Inventor: Nicola ROMANO, Pombia (IT)

(73) Assignee: COFIMCO S.R.L, POMBIA (IT)

(21) Appl. No.: 18/722,667

(22) PCT Filed: Dec. 21, 2022
(86) PCT No.: PCT/IB2022/062568

§ 371 Date: Jun. 21, 2024

(30) Foreign Application Priority Data
Dec. 22, 2021 (IT) 102021000032258

(51) Int. Cl. F04D 29/38; F04D 19/00; F04D 29/36

(52) U.S. Cl. CPC F04D 29/384; F04D 19/002; F04D 29/36; F05D 2240/30

(57) ABSTRACT

A blade for an industrial axial fan has a first wing-shaped body having a first leading edge and a first trailing edge; a second wing-shaped body having a second leading edge and a second trailing edge inclined with respect to said keying axis and the first leading edge and the second trailing edge; and a third wing-shaped body having a third leading edge and a third trailing edge inclined with respect to said keying axis in the opposite direction to the inclination of the second leading edge and to the second trailing edge so as to define an entry vertex between the second and third leading edges.

### CROSS-REFERENCE TO RELATED APPLICATIONS

This patent application claims priority from Italian Patent Application No. 102021000032258 filed on Dec. 22, 2021 the entire disclosure of which is incorporated herein by reference.

### TECHNICAL FIELD

The present invention relates to an industrial axial fan blade.

### BACKGROUND

As is well known, an industrial axial fan has a minimum diameter of about one metre and comprises a hub and a plurality of blades extending substantially in a radial direction from the hub.

The hub rotates about an axis and is connected to an electric motor to receive a rotary motion via a transmission system.

The blades have a wing-shaped profile so that, due to the rotation imparted by the motor, a pressure difference is generated between the extrados and intrados of the blades.

In turn, the pressure difference produces a flow of air in a direction substantially parallel to the axis of the hub.

The air flow rate set in motion in the axial direction depends on various factors, mainly the rotational speed, the shape of the wing-shaped profile and the pitch angle of the blades.

It is well known that, given a certain rotational speed, the angle of incidence (i.e. the angle between the airspeed vector and the blade chord) is determined by the pitch angle and cannot exceed a critical threshold or stall angle.

Below the critical threshold, in fact, the airflow along the blade surface is laminar and allows the curvature of the blade's extrados and intrados to be properly utilised for lift. Turbulence is confined downstream of the point where the flows that lap the extrados and the intrados meet, i.e. substantially downstream of the trailing edge of the blade.

If, on the other hand, the angle of incidence exceeds the critical threshold (stall angle), the flows that lap the extrados and intrados are unable to be reunited uniformly, break away from the blade surface, and cause vortices downstream of the breakaway point. Detachment generally occurs from the peripheral regions of the blade, where the tangential velocity is highest.

Vortices cause a loss of lift and, consequently, a drop in fan efficiency. In practice, the flow rate set in motion does not increase or even decreases with a corresponding increase in the energy absorbed by the motor driving the fan.

In the blades of an axial industrial fan, for a given rotational speed, the radial speed changes along the blade resulting in a change in the angle of incidence, which can thus vary along the blade itself.

In principle, the problem can be at least partly solved by the use of warped blades, so that the angle of attack varies along the radial direction. As is clear, the relative velocity between the blade and the airflow increases with the distance from the axis of rotation and, therefore, detachment occurs under different conditions at the root and at the top (tip) of the blade. Warping makes it possible to change the angle of attack according to the distance from the axis of rotation and to balance the need for high lift and efficiency on the one hand and the need to avoid vorticity and flow detachment from the blade surface on the other. A further advantage of warping is that it distributes the aerodynamic load more evenly along the blade which, in the absence of warping, would be concentrated in the fast part (tip) of the blade, thus aggravating the bending moment acting on the blade root.

However, the simplest and most advantageous manufacturing processes for large industrial fan blades, normally no less than one metre in diameter, based on extrusion and/or pultrusion techniques, are not suitable to undergo warping. Extrusion and/or pultrusion products through dies have a substantially uniform and straight hollow structure and the warping must be impressed by cold deformation processes, resulting in lower mechanical strength and high costs.

A good compromise, for extruded and pultruded blades, is obtained by an oblique cut of the trailing edge, which has, as an effect, a reduction of the chord at the tip (tapering) and a reduction of the pitch angle at the trailing edge (partial warping).

As mentioned, the problem is typical for large industrial fans, whereas smaller fan blades can be manufactured using different and more flexible techniques, such as moulding.

The aforementioned turbulence not only causes a loss of efficiency, but is also a source of noise.

Patent application WO2017/085134 proposes an axial industrial fan blade.

The blade extends along a keying axis and comprises a root wing body and an end wing body joined and angled to each other so that the projection of the blade itself is V-shaped. According to the configuration described, the leading edge of the end wing body and the end of the blade form an entry vertex which is the most forward part of the blade with respect to the direction of rotation.

The axis of the blade's keying axis coincides with the blade's keying shaft in relation to the hub for adjusting the blade's angle of incidence.

This shaft is placed inside the blade in the vicinity of the leading edge where the wing profile provides more space for the shaft to be inserted.

The result is that the blade of WO2017/085134 has a strongly unbalanced distribution of masses around the keying axis.

This means that adjusting the blade's pitch angle results in significant displacements of the vertex formed by the trailing edges of the wing root and wing tip body, with negative consequences for noise, efficiency and the forces acting on the blade.

### SUMMARY

The purpose of the present invention is thus to provide an industrial axial fan blade that is capable of mitigating the disadvantages of the known art.

According to the present invention, a blade with a wing profile for an industrial axial fan is provided, the blade extending along a given keying axis and comprising:
a first wing-shaped body having a first leading edge and a first trailing edge;
a second wing-shaped body having a second leading edge and a second trailing edge inclined with respect to said keying axis and the first and second trailing edge; and
a third wing-shaped body having a third leading edge and a third trailing edge inclined with respect to said keying axis in the opposite direction to the inclination of the second leading edge and to the second trailing edge, so as to define a leading edge between the second and the third leading edges.

In this way, the blade takes on a hook shape that combines low noise, high efficiency and a balanced distribution of mass around the radial axis.

In particular, the third wing-shaped body comprises an end edge with a circumferential profile around an axis of rotation of the blade for the benefit of reducing the pressure gradient.

In particular, the blade comprises a keying shaft aligned to and rotatable about said keying axis to adjust the blade's angle of incidence, the keying shaft being fixed to the first wing-shaped body in the vicinity of the leading edge.

The wing profile of the wing-shaped body offers the possibility of inserting the keying shaft in the vicinity of the leading edge.

In particular, the first leading edge is parallel to the keying axis and, in particular, the first trailing edge is parallel to the keying axis.

This configuration allows the first wing-shaped body to be advantageously produced by an extrusion and/or pultrusion process.

The same extrusion and/or pultrusion technique can also be used in the construction of the second and third wing-shaped bodies in view of the fact that the second leading edge and the second trailing edge are essentially parallel to each other just as the third leading edge and the third trailing edge are essentially parallel to each other.

The conformation of the hook-shaped blade is determined by the angles formed between the first and second wing-shaped bodies and between the second and third wing-shaped bodies.

Specifically, the first and second leading edges form a first obtuse angle, in particular comprised between 100° and 170°; the second and third leading edges form a second angle greater than 180° and in particular comprised between 200° and 300°; the first and second trailing edges form a third angle greater than 180° and in particular comprised between 200° and 300°; and the second and third trailing edges form a fourth obtuse angle and in particular comprised between 100° and 170°.

The choice of angles makes it possible to arrange the third leading edge with such an inclination with respect to the keying axis that the vector of the relative air velocity along the third leading edge forms a fifth acute angle with said third leading edge and reduces the change of direction of the air in the fastest portion of the blade.

The hook shape of the blade also allows the centres of gravity of the first, second and third wing-shaped bodies to be arranged from different bands with respect to the keying axis and in the vicinity of the keying axis.

The present invention also relates to an industrial axial fan comprising a hub rotatable about an axis of rotation and a plurality of blades mounted on said hub, wherein each blade is made in accordance with one or more of the features described above.

In particular, the keying axis of each blade extends radially with respect to the axis of rotation, and each blade is selectively adjustable around said keying axis to vary the blade's axis of incidence.

### BRIEF DESCRIPTION OF THE DRAWINGS

The present invention will now be described with reference to the enclosed drawings, showing some non-limiting embodiments thereof, wherein:

FIG. 1 is a simplified block diagram of an axial fan according to a first embodiment of the present invention;

FIG. 2 is a plan view from above of the axial fan of FIG. 1;

FIGS. 3 to 5 are plan views, in an enlarged scale and with parts removed for clarity, of an industrial axial fan blade of FIG. 2; and

FIGS. 6 and 7 are plan views, with parts removed for clarity, of two respective variants of the blade of FIGS. 3 to 5.

### DESCRIPTION OF EMBODIMENTS

The invention described below is particularly suitable for large axial fans, for example for heat exchangers used in natural gas liquefaction plants, refineries or combined cycle or steam turbine power plants.

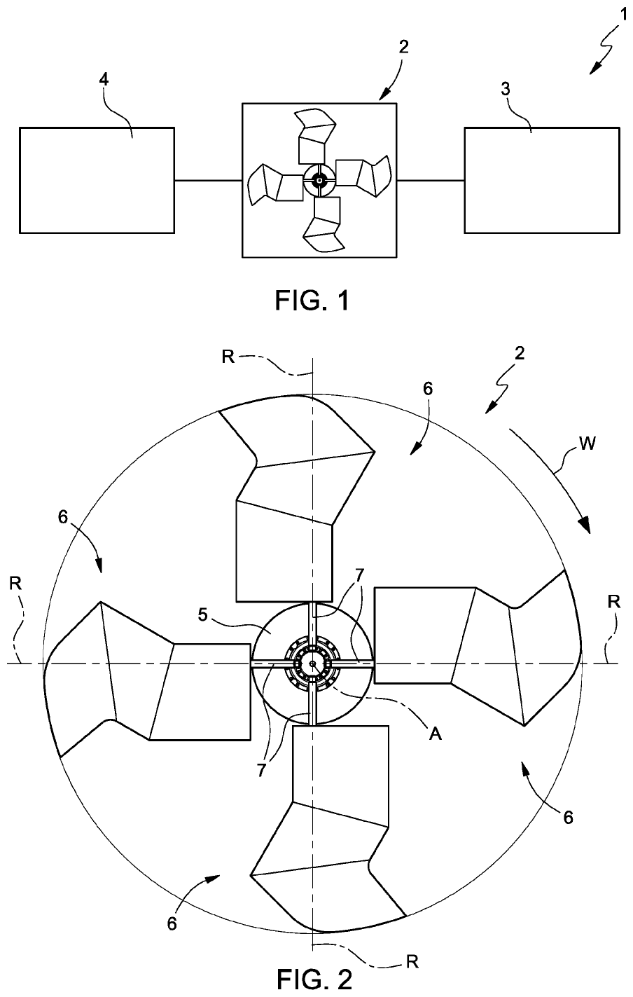

With reference to FIGS. 1 and 2, a fan assembly, denoted as a whole by the number 1, comprises an axial fan 2 driven by an electric motor 3 and an actuator 4 controlling the axial fan 2.

The axial fan 2, which is depicted in more detail in FIG. 2, comprises a hub 5, connected to a shaft of the electric motor 3, and a plurality of blades 6 extending from the hub 5 substantially in a radial direction.

The blades 5 6 can be made by extrusion or pultrusion, e.g. of aluminium or plastic, or by moulding in glass fibre or carbon fibre reinforced composite material.

The blades 6 are also connected to the hub 5 via respective shafts 7.

In one embodiment, the shafts 7 are orientable about respective keying axes coincident with the keying shaft 7 to enable the pitch angle of the blades 6 to be adjusted by means of the actuator 4 (FIG. 1) and the angle of incidence to be varied.

As shown in FIG. 3, each blade 6 comprises three wing-shaped bodies 8, 9, 10 with respective airfoils.

The wing-shaped body 8 is rigidly attached to the respective keying shaft 7 and has a proximal end 8a; a distal end 8b; a leading edge 8c; and a trailing edge 8d. In the configuration illustrated, the leading edge 8c and trailing edge 8d are parallel to the keying axis A.

According to a variant not illustrated in the attached Figures, the trailing edge has a variously shaped profile as a result of subsequent machining of a semi-finished wing-shaped body with a parallel trailing and leading edge made by extrusion and/or pultrusion.

The wing-shaped body 9 has a proximal end 9a rigidly connected and adjacent to the distal end 8b of the wing body 8; a distal end 9b; a leading edge 9c; and a trailing edge 9d.

The leading edge 9c and trailing edge 9d are inclined with respect to the keying axis A.

The wing-shaped body 10 has a proximal end 10a rigidly connected and adjacent to the distal end 9b of the wing body 9; a free distal end 10b; a leading edge 10c; and a trailing edge 10d.

The leading edge 10c and trailing edge 10d are inclined with respect to the keying axis A in the opposite direction to the leading and trailing edges 9c and 9d.

The free end 10b defines the so-called blade tip 6 and has a substantially circumferential curved profile connected to the leading edge 10c.

In practice, the wing-shaped body 10 is made from an extruded and/or pultruded profile and a cap coupled to the profile.

The cap closes the profile and defines the free end of the circumferential blade.

In the illustrated case, the proximal end 8a is straight and substantially perpendicular to the keying axis A and the distal end 8b is straight and inclined with respect to the keying axis A such that the length of the trailing edge 8d is less than the length of the leading edge 8c.

In practice, the wing-shaped body 8 in the plan view is shaped like a rectangular trapezoid.

In accordance with a variant not shown in the attached figures, the wing-shaped body adjacent to the hub has a circumferential distal edge in order to reduce the gaps between the blade and the hub and reverse flow.

The proximal end 9a coincides with the distal end 8b and the distal end 9b is inclined in the opposite direction to the proximal end 9a so that the wing-shaped body 9, in the plan view, is shaped like a scalene trapezium.

The leading edge 9c and the leading edge 10c converge at a leading vertex 11, which defines the most forward point of the blade 6 in the direction of rotation W of the axial fan 2 (FIG. 2).

The trailing edge 10d and the distal end 10b converge at a trailing vertex 12 which is arranged at the rearmost point of the blade 6 with reference to the direction of rotation of the axial fan 2.

The leading edges 8c and 9c are essentially straight and form an obtuse angle F1, while the leading edges 9c and 10c form an F2 angle greater than 180° (reflex angle).

The trailing edges 8d and 9d form an angle F3 greater than 180° (reflex angle) while the leading edges 9d and 10d form an obtuse angle F4.

The blade 6 has a chord C that remains constant from the proximal end 8a as the radius along the wing-shaped body 8 increases and grows along the wing-shaped body 9.

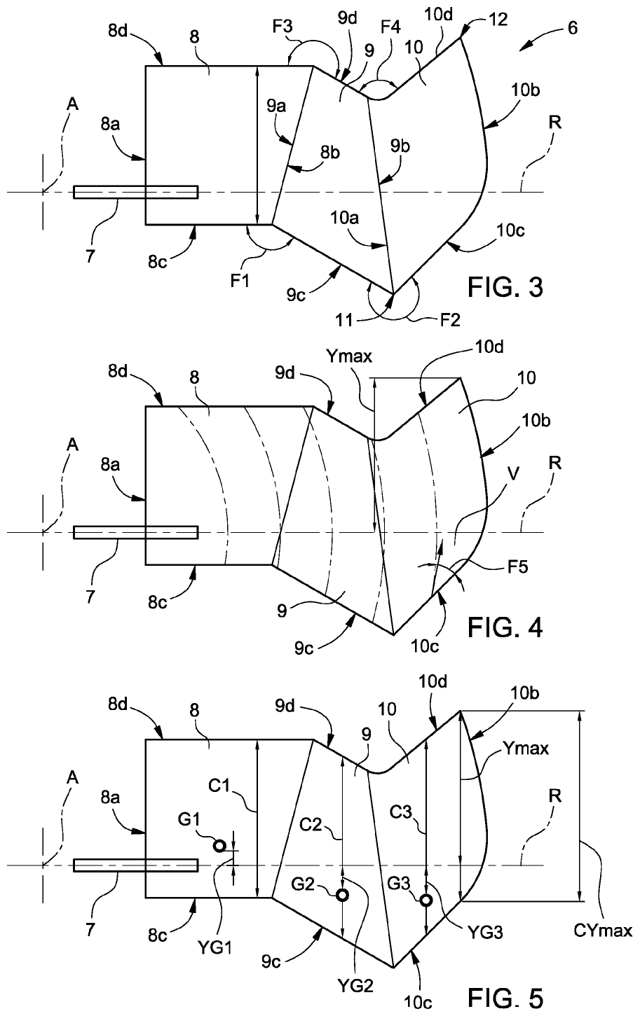

With reference to FIG. 4, the relative velocity V of the air with respect to the blade 6 at a point at the distal end 10b where the relative velocity takes its maximum value is illustrated.

At the indicated point, the relative velocity V forms an acute angle F5 and is relatively small with the leading edge 10c, which ensures low airflow deflection at the indicated point.

With reference to FIG. 5, the centres of gravity G1, G2 and G3 of the wing-shaped bodies 8, 9 and 10 respectively are shown along the blade 6.

The centre of gravity G1 is located at a distance YG1 from the keying axis A and is positioned between the keying axis A and the trailing edge 8d.

The centre of gravity G2 is located at a distance YG2 from the keying axis A and is positioned between the keying axis A and the leading edge 9c.

The centre of gravity G3 is located at a distance YG3 from the keying axis A and is positioned between the keying axis A and the leading edge 10c.

The ratio of the distance YG1 to the chord C1 at point G1 is less than or equal to 1/7.

The same is true for the ratio YG2/C2 and YG3/C3, which means that points G1, G2 and G3 are relatively close to the keying axis A with respect to the dimensions of the blade 6.

In addition, the centre of gravity G1 is arranged on one band with respect to the keying axis A while the centres of gravity G2 and G3 are arranged on the opposite band with respect to the keying axis A.

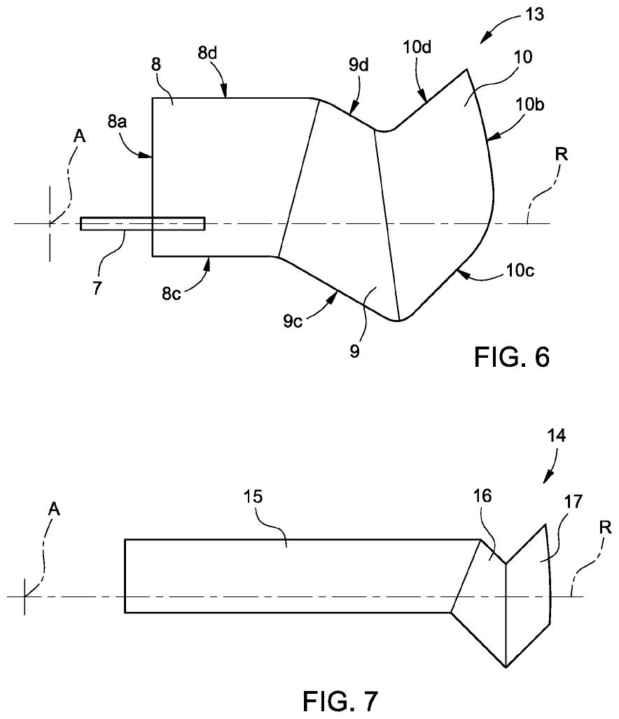

With reference to the variant in FIG. 6, a blade 13 is illustrated which differs from the blade 6 in that the leading edges 8c, 9, c and 10c are joined together by curved edges.

The trailing edges 8b and 9d are also connected to each other by a curved edge unlike the blade 6 (FIGS. 3-5).

With reference to the variant in FIG. 7, a blade 14 is illustrated in which the radial dimension is preponderant over the circumferential dimension.

The blade 14 comprises three wing-shaped bodies 15, 16 and 17 which are arranged in succession and where the proximal wing-shaped body 15 defines most of the radial dimension and the wing-shaped bodies 16 and 17 define a portion of the end of the blade 14 itself.

It is finally clear that modifications and variants can be made to the disclosed axial fan, without departing from the scope of the present invention, as defined in the enclosed claims.

In particular, the diameter and number of blades of the axial fan may vary from what is described.

The connection between the blades and the hub may also differ from what is described.

Among other things, the blades can be connected to the hub at a fixed angle.

In addition, blades may be without end elements and/or brackets with an aerodynamic configuration, for example if not required for a specific application.

1. Industrial axial fan blade, the blade (6; 13; 14) extending along a given keying axis (R) and comprising:
a first wing-shaped body (8; 15) having a first leading edge (8c) and a first trailing edge (8d);
a second wing-shaped body (9; 16) having a second leading edge (9c) and a second trailing edge (9d) inclined with respect to said keying axis (R) and said first leading edge (8c) and second trailing edge (8d); and
a third wing-shaped body (10) having a third leading edge (10c) and a third trailing edge (10d) inclined with respect to said keying axis (R) in the opposite direction to the inclination of the second leading edge (9c) and to the second trailing edge (9d), so as to define a leading edge between the second and the third leading edges (9c, 10c).

2. The blade as claimed in claim 1, wherein the third wing-shaped body (10) comprises an end edge (10b) preferably having a circumferential profile about an axis of rotation (A).

3. The blade as claimed in claim 1, and comprising a keying shaft (7) aligned with said keying axis (R) and rotatable about said keying axis (R) to adjust the pitch angle of the blade (6), in particular the keying shaft (7) is fixed to the first wing-shaped body (8, 15) in the vicinity of the leading edge (8c).

4. The blade as claimed in claim 1, wherein the first leading edge (8c) is parallel to the keying axis (R) and, in particular, the first trailing edge (8d) is parallel to the keying axis (R).

5. The blade as claimed in claim 1, wherein the second leading edge (9c) and the second trailing edge (9d) are substantially parallel to each other.

6. The blade as claimed in claim 1, wherein the third leading edge (10c) and the third trailing edge (10d) are substantially parallel to each other.

7. The blade as claimed in claim 1, wherein the first and second leading edges (8c, 9c) form a first obtuse angle (F1), in particular between 100° and 170°.

8. The blade as claimed in claim 1, wherein the second and third leading edges (9c, 10c) form a second angle (F2) greater than 180° and, in particular, between 200° and 300°.

9. The blade as claimed in claim 1, wherein the first and second trailing edges (8d, 9d) form a third angle (F3) greater than 180° and, in particular, between 200° and 300°.

10. The blade as claimed in claim 1, wherein the second and third trailing edges (9d, 10d) form a fourth angle (F4) greater than 180° and, in particular, between 100° and 170°.

11. The blade as claimed in claim 1, wherein the third leading edge (10c) has an inclination with respect to the keying axis (R) such that the vector of the relative air velocity (V) along the third leading edge (10c) forms a fifth acute angle (F5) with said third leading edge (10c).

12. An industrial axial fan comprising a hub (5) rotatable about a rotation axis (A) and a plurality of blades (6; 13; 14) mounted on said hub (5), wherein each blade (6; 13; 14) is made in accordance with claim 1.

13. The axial fan according to claim 12, wherein the keying axis (R) of each blade (6; 13; 14) extends radially with respect to the axis of rotation (A).

14. The axial fan according to claim 12, wherein each blade (6; 13; 14) is selectively pivotable about said keying axis (R).
